(19) United States
(12) Patent Application Publication
(10) Pub. No.: US 2010/0244768 A1
(43) Pub. Date: Sep. 30, 2010

(54) AUTOMOTIVE FOB SYSTEM

(75) Inventors: Riad Ghabra, Dearborn Heights, MI (US); John Nantz, Brighton, MI (US); Mark Ousachi, West Bloomfield, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/415,164

(22) Filed: Mar. 31, 2009

(51) Int. Cl. H02J 7/00

(52) U.S. Cl. 320/108

(57) ABSTRACT

An automotive fob system may include an automotive fob and a fob charging receptacle. The automotive fob may have a loop feature, and include a power storage unit and a first inductive coil electrically connected with the power storage unit. The first coil may form a loop and be disposed in the loop feature. The fob charging receptacle may include a magnetic core configured to be inserted into the loop feature, and a second inductive coil wrapped around the core. The second inductive coil may be adapted to receive electrical current from a remote power source if electrically connected with the remote power source.

### BACKGROUND

U.S. Pat. No. 7,301,442 to Kolpasky et al. provides a multi-functional fob that includes at least one of the features selected from a programmable lock/unlock button, a voice activated button, an ice-scraper, a credit card strip, and a rechargeable interface. One or a combination of the features may be integrated into a single fob. A fob-retaining device may be provided. Each fob function may be integrated into an electronic device such as a PDA, a cellular phone, a two-way radio, a wristwatch, a voice recorder, an audio player, a video player, or a multi-communication signal fob repeater. Optionally, the fob may have a compass and a timer. Additionally, a multi-functional fob communication system provides remote communications between a receiver in a fob-activated device and a remote electronic fob device.

U.S. Pat. No. 6,943,666 to Mooney et al. provides a key chain rechargeable device which is recharged when a key is inserted into a matching lock. The key includes two electrical contacts, or is separated into two electrically isolated portions. The two electrical contacts (or portions of the key) contact mating contacts in the matching lock only when the key is inserted therein. Alternatively, inductive coupling is used when the key chain rechargeable device is proximate to a matching lock of a key associated therewith. A charging circuit may be integrated in the key chain rechargeable device, or in the external device associated with the lock. The key chain rechargeable device may be a wireless device such as a BLUETOOTH network device, pager, a security alarm enable/disable device, garage door opener, or a keyless entry remote. The key relates to a vehicle ignition key, and the key chain rechargeable device is recharged during operation of a vehicle.

U.S. Pat. No. 6,184,651 to Fernandez et al. provides a contactless charging system where charging energy is transferred across an inductive coupler to charge a battery of a portable device, such as a two-way radio, cellular phone, paging device, or wireless communicator. The inductive coupler also provides a way for communicating at least one signal, such as to improve the charging process and the transfer of charging energy. Charging efficiency is improved by voltage regulation using feedback through the inductive coupler, or via a wireless RF link, and a controller in-circuit with the primary side of the inductive coupler. The controller may communicate information signals via inductive coupling, or via a wireless RF link, for communicating with other devices such as smart cards and microphones or for control or data transfer.

### SUMMARY

An automotive fob system includes an automotive fob and a fob charging receptacle. The automotive fob has a loop feature and includes a power storage unit and a first inductive coil electrically connected with the power storage unit. The first coil forms a loop and is disposed in the loop feature. The fob charging receptacle includes a magnetic core configured to be inserted into the loop feature, and a second inductive coil wrapped around the core. The second inductive coil is adapted to receive electrical current from a remote power source if electrically connected with the remote power source.

The first and second coils may inductively couple if electrical current from the remote power source is flowing through the second coil and the magnetic core is inserted into the loop feature.

The fob charging receptacle may further include a surface configured to receive the fob. The magnetic core may project away from this surface.

The loop feature may be a key loop.

The magnetic core may comprise metal.

The power storage unit may be a battery or capacitor.

An automotive fob has a loop feature and includes a charging coil and a power storage unit electrically connected with the coil. The coil forms a loop and is disposed within the loop feature.

The fob may further include a display and a radio frequency transceiver.

An automotive fob includes a radio frequency transceiver, a display, a power storage unit, and a coil. The coil is electrically connected with the power storage unit and capable of inductively coupling with a charging coil.

The fob may include a loop feature. The coil may form a loop and be disposed in the loop feature.

While example embodiments in accordance with the invention are illustrated and disclosed, such disclosure should not be construed to limit the invention. It is anticipated that various modifications and alternative designs may be made without departing from the scope of the invention.

### BRIEF DESCRIPTION OF THE DRAWINGS

FIG. 1 is a schematic plan view, in cross-section, of an embodiment of an automotive fob;

FIG. 2 is a schematic plan view, in cross-section, of an embodiment of a cradle for changing the fob of FIG. 1;

FIG. 3 is a schematic side view, in cross-section, of the cradle of FIG. 2; and

FIG. 4 is a perspective view of the fob of FIG. 1 and the cradle of FIGS. 2 and 3.

### DETAILED DESCRIPTION

The size of automotive fobs may be minimized to facilitate ease of user transport. As a result, packaging constraints may limit the amount of space available to position user interfaces, such as buttons and a display screen, on certain multi-functional fobs. Other fob components, such as a transceiver and battery, may also compete for available space within the fob.

The use of a fob's display screen and transceiver may require the fob's battery to be recharged. Inductive charging techniques may be used to recharge the battery. An inductive coil, however, may need to be packaged within the fob to permit such inductive charging. This inductive coil may occupy space needed for other fob components.

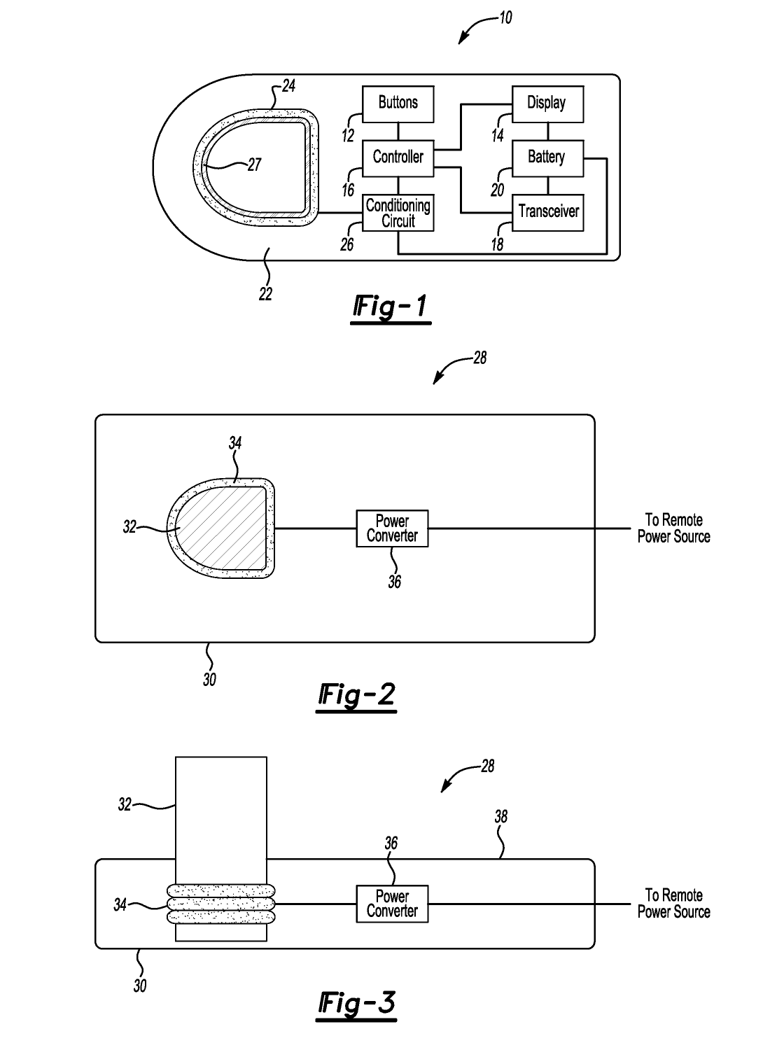

Referring now to FIG. 1, an embodiment of an automotive fob 10 may include one or more buttons 12 and a display 14. The buttons 12 may be used to input commands, e.g., unlock doors, start vehicle, etc., to the fob 10. The display 12 (LCD, LED, etc.) may be used to display information received from a vehicle, etc. The fob 10 may also include a controller 16, transceiver 18 and power storage unit 20 (e.g., battery, capacitor, etc.). The controller 16 may interpret the input from the buttons 12 and issue the appropriate commands to the transceiver 18. The transceiver 18 may then generate command signals for transmission to a vehicle. The transceiver 18 may also receive, for example, information bearing signals from the vehicle and pass them to the controller 16. The battery 20 may be used as power source for the display 14 and transceiver 18.

As discussed above, the inclusion of a display 14 and transceiver 18 within the fob 10 may result in increased power consumption by the fob 10 relative to fobs that lack a display and/or transceiver. Furthermore, packaging constraints within the fob 10 may limit the available space for the power storage unit 20 (as well as the other fob components discussed). As a result, the power storage unit 20 is rechargeable so as to address issues with increased power consumption and limited packaging space. If the power storage unit 20 were not rechargeable, it may not be able to store enough power to support the usage of the display 14 and transceiver 18 during the lifetime of the fob 10.

The fob 10 may further include a loop feature 22 (e.g., a key loop), inductive charging coil 24 and power conditioning circuitry 26. In the embodiment of FIG. 1, the loop feature 22 is formed on a side of the fob 10. In other embodiments, the loop feature 22 may extend from, for example, a top or bottom of the fob 10 as desired, etc.

In certain embodiments, the loop feature 22 may be formed as part of the fob's hollow casing and include a wall portion 27 that extends between a top and bottom of the fob 10. The wall portion 27 may define an inner diameter of the loop feature 22. In other embodiments, the loop feature 22 and coil 24 may be separately assembled and then fixedly attached with the fob 10. Other arrangements are also possible. For example, the loop feature 22 (and thus the coil 24) may be removedly attached with the fob 10 via, for example, a snap feature. In these embodiments, electrical contacts may be provided on the loop feature 22 and fob 10 to facilitate the electrical connection of the coil 24 and circuitry 26.

The coil 24 may form a loop and be embedded/located/wound within the loop feature 22. In the embodiment of FIG. 1, the coil is wound around the wall portion 27. Other arrangements are also possible. For example, the coil 24 may be molded in place with the loop feature 22. By positioning the coil 24 within the loop feature 22, the coil 24 does not occupy space within other portions of the fob 10. Such a configuration preserves packaging space for other components (e.g., buttons 12, display 14, etc.) of the fob 10. (In other embodiments, the coil 24 may, of course, be disposed in any desired location within the fob 10. Other suitable recharging technologies, e.g., direct electric connection, etc., may also be used.)

The circuitry 26 is electrically connected with the coil 24 and battery 20. Electrical current received by the circuitry 26 from the coil 24 is conditioned, in a known fashion, prior to storage by the battery 20.

Referring now to FIGS. 2 and 3, a charging cradle 28 for the fob 10 illustrated in FIG. 1 includes a body portion 30, magnetic core 32 (e.g., iron core, zinc-manganese core, etc.), inductive charging coil 34, and power converter 36. The body portion 30 includes a fob receiving surface 38. As explained below, the fob 10 illustrated in FIG. 1 may be positioned on the surface 38 such that the core 32 passes through the loop feature 22 (and thus the coil 24) of the fob 10.

The core 32 may extend into the body portion 30 and away from the surface 38. The core 32 of FIG. 2 has a shape complimentary to the loop feature 22 illustrated in FIG. 1. In other embodiments, the core 32 may have any suitable shape that facilitates its insertion into the loop feature 22. For example, if the loop feature 22 is circular, the core 32 may be cylindrically shaped, etc. Moreover, if the cradle 28 is adapted to hang on a wall or integrated within a vehicle, the core 32 may be shaped as a hook, etc.

The coil 34 may be wrapped around the core 32. The diameter and number of windings of the coil 34 (as well as the coil 24 illustrated in FIG. 1) may be selected, in a known fashion, to, for example, optimize inductive coupling between the coils 24, 34 as well as the space occupied by the coils 24, 34. In other embodiments, however, the coil 34 may be positioned within the cradle 28 in any suitable location.

The converter 36 may be electrically connected with the coil 34 and a remote power source such as an electrical wall outlet (via a an electrical plug), a laptop computer (via USB), a vehicle battery, etc. Alternating current from the remote power source may be converted to direct current, in a known fashion, by the converter 36 and provided to the coil 34. Of course, embodiments adapted to receive power from a direct current power source may not need the converter 36. As apparent to those of ordinary skill, current passing through the coil 34 generates an electromagnetic field that may induce current flow in another coil in the vicinity of the electromagnetic filed.

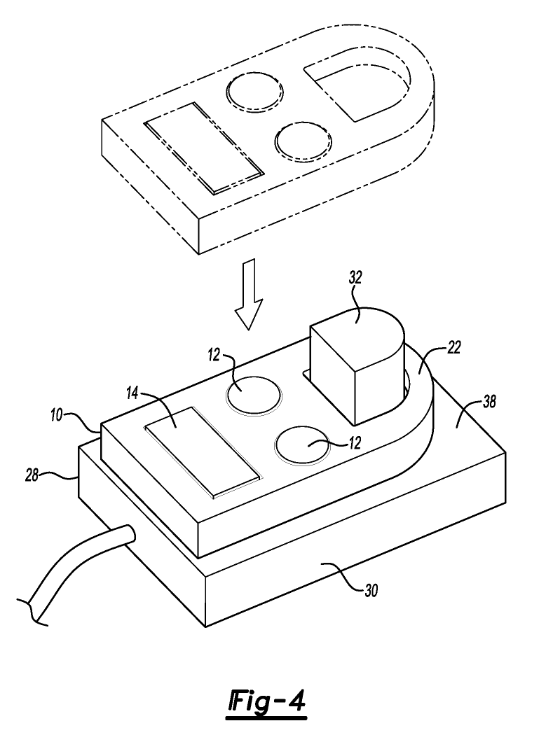

Referring now to FIGS. 1, 2, 3 and 4, the fob 10 has been positioned on the cradle 28 such that the core 32 passes through the loop feature 22, and thus the coil 24. The coils 24, 34 now share the same axis. As discussed above, the electromagnetic field generated by the coil 34 when current is flowing there through induces current flow through the coil 24 when the fob 10 is positioned as illustrated, thus charging the power storage unit 20. As apparent to those of ordinary skill, the core 32 improves the inductive coupling between the coils 24, 34 by concentrating the electromagnetic field.

While embodiments of the invention have been illustrated and described, it is not intended that these embodiments illustrate and describe all possible forms of the invention. The words used in the specification are words of description rather than limitation, and it is understood that various changes may be made without departing from the spirit and scope of the invention.

What is claimed is:

1. An automotive fob system comprising:
an automotive fob having a loop feature and including (i) a power storage unit and (ii) a first inductive coil electrically connected with the power storage unit, the first coil forming a loop and disposed in the loop feature; and
a fob charging receptacle including (i) a magnetic core configured to be inserted into the loop feature and (ii) a second inductive coil wrapped around the core and adapted to receive electrical current from a remote power source if electrically connected with the remote power source.

2. The system of claim 1 wherein the first and second coils inductively couple if electrical current from the remote power source is flowing through the second coil and the magnetic core is inserted into the loop feature.

3. The system of claim 1 wherein the fob charging receptacle further includes a surface configured to receive the fob, and wherein the magnetic core projects away from the surface.

4. The system of claim 1 wherein the loop feature is a key loop.

5. The system of claim 1 wherein the magnetic core comprises metal.

6. The system of claim 1 wherein the power storage unit is a battery.

7. The system of claim 1 wherein the power storage unit is a capacitor.

8. An automotive fob having a loop feature and including (i) a charging coil and (ii) a power storage unit electrically connected with the coil, the coil forming a loop and disposed within the loop feature.

9. The fob of claim 8 further including a display and a radio frequency transceiver.

10. The fob of claim 8 wherein the loop feature is a key loop.

11. The fob of claim 8 wherein the power storage unit is a battery.

12. The fob of claim 8 wherein the power storage unit is a capacitor.

13. An automotive fob including a radio frequency transceiver, a display, a power storage unit, and a coil (i) electrically connected with the power storage unit and (ii) capable of inductively coupling with a charging coil.

14. The fob of claim 13 wherein the fob includes a loop feature and wherein the coil forms a loop and is disposed in the loop feature.

15. The fob of claim 13 wherein the loop feature is a key loop.

16. The fob of claim 13 wherein the power storage unit is a battery.

17. The fob of claim 13 wherein the power storage unit is a capacitor.
